(19) United States
(12) Patent Application Publication
(10) Pub. No.: US 2026/0107192 A1
(43) Pub. Date: Apr. 16, 2026

(54) Methods And Apparatus For Handover-Related Status Reporting

(71) Applicant: MediaTek Singapore Pte. Ltd., Singapore (SG)

(72) Inventors: Miao Wang, Beijing (CN); Tsang-Wei Yu, Hsinchu (TW)

(73) Assignee: MediaTek Singapore Pte. Ltd., Singapore (SG)

(21) Appl. No.: 19/357,126

(22) Filed: Oct. 14, 2025

(30) Foreign Application Priority Data
Oct. 9, 2025 (CN) 202511440093.4
Oct. 16, 2024 (CN) PCT/CN2024/125310

(51) Int. Cl. H04W 36/00; H04W 74/0833

(52) U.S. Cl. CPC H04W 36/0058; H04W 74/0833

(57) ABSTRACT

Methods and apparatus pertaining to handover-related status reporting in mobile communications are described. An apparatus may transmit a report comprising information regarding an earliest time occasion that an interrupted time will start after receiving a handover command to a network node. The apparatus may receive the handover command from the network node. The apparatus may communicate with the network node after transmitting the report and before the interrupted time.

### CROSS REFERENCE TO RELATED PATENT APPLICATIONS

The present disclosure is part of a non-provisional application claiming the priority benefit of PCT Application No. PCT/CN2024/125310, filed 16 October 2024, and CN Application No. 202511440093.4, filed 09 October 2025, the contents of which herein being incorporated by reference in their entirety.

### TECHNICAL FIELD

The present disclosure is generally related to mobile communications and, more particularly, to handover-related status reporting in mobile communications.

### BACKGROUND

Unless otherwise indicated herein, approaches described in this section are not prior art to the claims listed below and are not admitted as prior art by inclusion in this section.

In a mobile communications network, when the User Equipment (UE) moves from the coverage area of one cell to another cell, a serving cell change may be performed. Serving cell change may be triggered by Layer 3 (L3) measurements and may be done by Radio Resource Control (RRC) signaling triggered by reconfiguration with synchronization for change of Primary Cell (PCell) and Primary Secondary Cell (PSCell), as well as release or add for Secondary cells (SCells) when applicable. However, this procedure requires complete resets of Layer 2 (L2) and Layer 1 (L1) configurations, resulting in significant latency, overhead, and interruption time.

Accordingly, how to reduce the handover interruption time is an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to handover-related status reporting in mobile communications.

In one aspect, a method may involve an apparatus transmitting a report comprising information regarding the earliest time occasion that an interrupted time will start after receiving a handover command to a network node. The method may also involve the apparatus receiving the handover command from the network node. The method may further involve the apparatus communicating with the network node after transmitting the report and before the interrupted time.

In one aspect, an apparatus may involve a transceiver which, during operation, wirelessly communicates with at least one network node. The apparatus may also involve a processor communicatively coupled to the transceiver. The processor, during operation, may perform operations comprising transmitting, via the transceiver, a report comprising information regarding the earliest time occasion that an interrupted time will start after receiving a handover command to the network node. The processor may also perform operations comprising receiving, via the transceiver, the handover command from the network node. The processor may further perform operations comprising communicating, via the transceiver, with the network node after transmitting the report and before the interrupted time.

In one aspect, a method may involve a network node receiving a report from an apparatus. The report may comprise information regarding the earliest time occasion that an interrupted time will start after the apparatus receives a handover command. The method may also involve the network node transmitting a handover command to the apparatus. The method may also involve the network node communicating with the apparatus after receiving the report and before the interrupted time.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an exemplary wireless network in accordance with implementations of the present disclosure.

FIG. 2 is a diagram depicting an example scenario of the handover procedure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example communication system having an example communication apparatus and an example network apparatus in accordance with an implementation of the present disclosure.

FIG. 7 is a diagram depicting an example process in accordance with an implementation of the present disclosure.

FIG. 8 is a diagram depicting another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handover-related status reporting in mobile communications. According to the present disclosure, a number of possible solutions may be implemented separately or jointly. That is, although these possible solutions may be described below separately, two or more of these possible solutions may be implemented in one combination or another.

As mentioned above, the handover procedure triggered by L3 measurements requires complete resets of L2 and L1 configurations, including clearing buffer states, restarting link control protocols, and reinitializing physical layer parameters such as synchronization and radio resource mappings, resulting in increased latency, overhead, and interruption time. To mitigate these issues, Layer 2-triggered Mobility (LTM) has been introduced in the 3^{rd} Generation Partnership Project (3GPP) Release 18, offering reduced interruption time and enhanced reliability over traditional methods.

When the RRC reconfiguration is applicable in the LTM preparation procedure, the UE may perform L1 measurements on the configured candidate cell(s) and transmit L1 measurement reports to the BS (such as a next generation Node-B (gNB)). The network may trigger the execution of the LTM procedure according to the L1 measurement reports from the UE and send the LTM cell switch command Medium Access Control (MAC) Control Element (CE) to the UE. When the UE receives the LTM cell switch command MAC CE, the UE may perform the LTM execution procedure and the LTM completion procedure.

A similar idea has been introduced in the conditional handover. The network is supposed to configure the condition to perform a handover. The UE may start the handover after the preconfigured condition is met without notifying the network. In this way, the latency introduced by the measurement report and handover command may be reduced. However, in conditional handover scenarios, the BS lacks sufficient information about the channel conditions. As a result, the target cell must prepare in advance for a potential handover, even though the handover might never occur. This premature preparation often leads to unnecessary consumption of network resources. In addition, from the perspective of the source cell, which is the current serving cell from which the UE initiates the handover to the target cell, since it has no knowledge of when the UE initiates the handover, it continues to schedule transmissions for the UE even after the handover procedure has already begun. This redundant scheduling results in further inefficiencies and unnecessary consumption of network resources. Both the long handover interruption time and unnecessary consumption of network resources pose significant challenges to ensuring seamless connectivity and network efficiency.

In light of these issues, various techniques, methods, schemes and/or solutions related to handover-related status reporting in mobile communication systems, including handover-related preparation and preparation status reporting, are proposed to reduce/improve the handover interruption time and improve resource allocation efficiency.

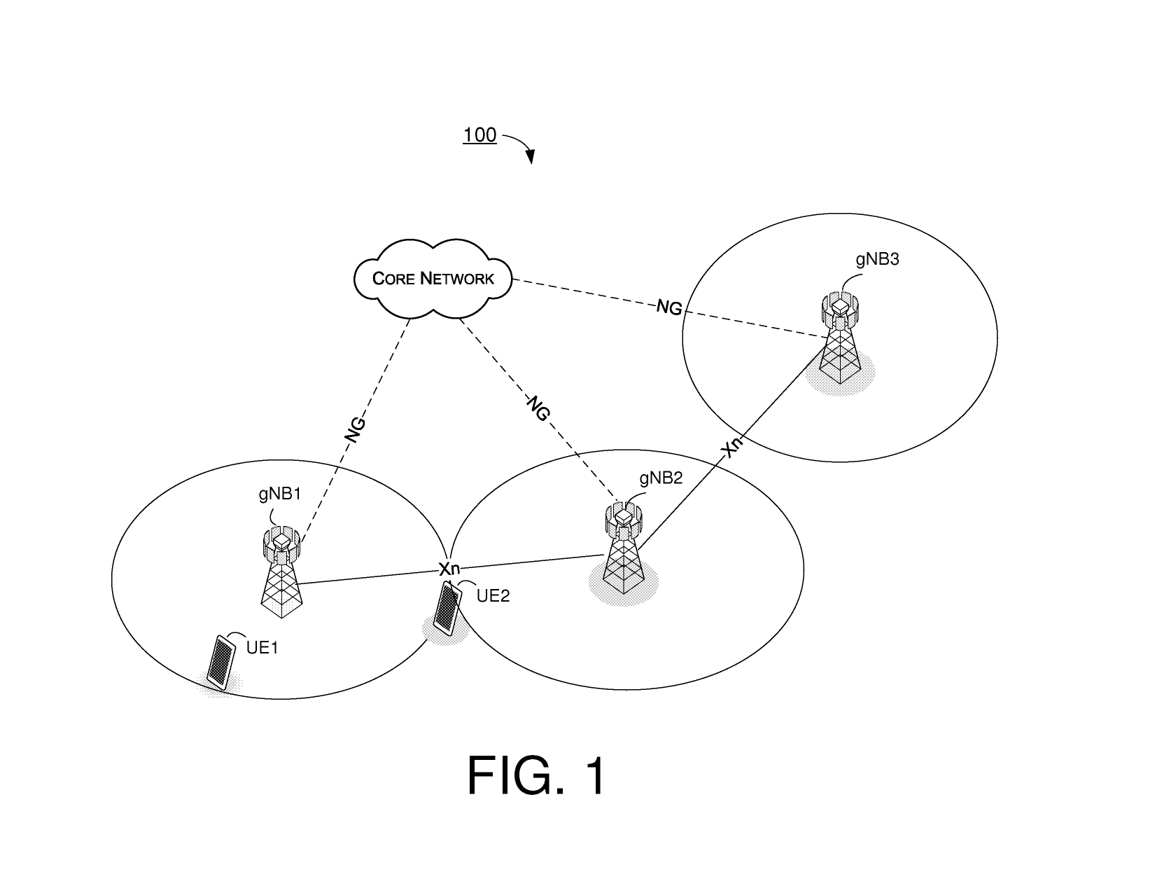

FIG. 1 illustrates an example scenario 100 of an exemplary wireless network in accordance with implementations of the present disclosure. The wireless communication system may comprise one or more fixed base infrastructure units forming a network distributed over a geographical region. The base unit may also be referred to as an access point, an access terminal, a BS, a Node-B, an eNode-B, a gNB, or by other terminology used in the art. As an example, the base stations may serve a number of mobile stations within a serving area, for example, a cell, or within a cell sector. In some systems, one or more base stations may be coupled to a controller forming an access network that is coupled to one or more core networks.

In scenario 100, the gNB1, gNB2 and gNB3 are base stations in NR, and the serving areas of which may or may not overlap with each other. As an example, the UE1 may be in the service area of gNB1, and the UE2 may be in the overlapping service area of gNB1 and gNB2. The gNB2 may be connected with the gNB1 and the gNB3 via the Xn interface, and the gNBs may interface with the core network through backhaul links. The core network may comprise at least an Access and Mobility Management Function (AMF) and a User Plane Function (UPF). The gNBs may connect to the AMF over the Next Generation (NG) Interface. The AMF may be the control node that processes the signaling between the UEs and the core network. During the handover process, the AMF is responsible for tracking user location and managing mobility. The AMF may coordinate the switching procedure between base stations (e.g., the gNBs) to minimize service disruption. The UPF is responsible for re-routing user data according to the instructions from the AMF, helping maintain a smooth data flow.

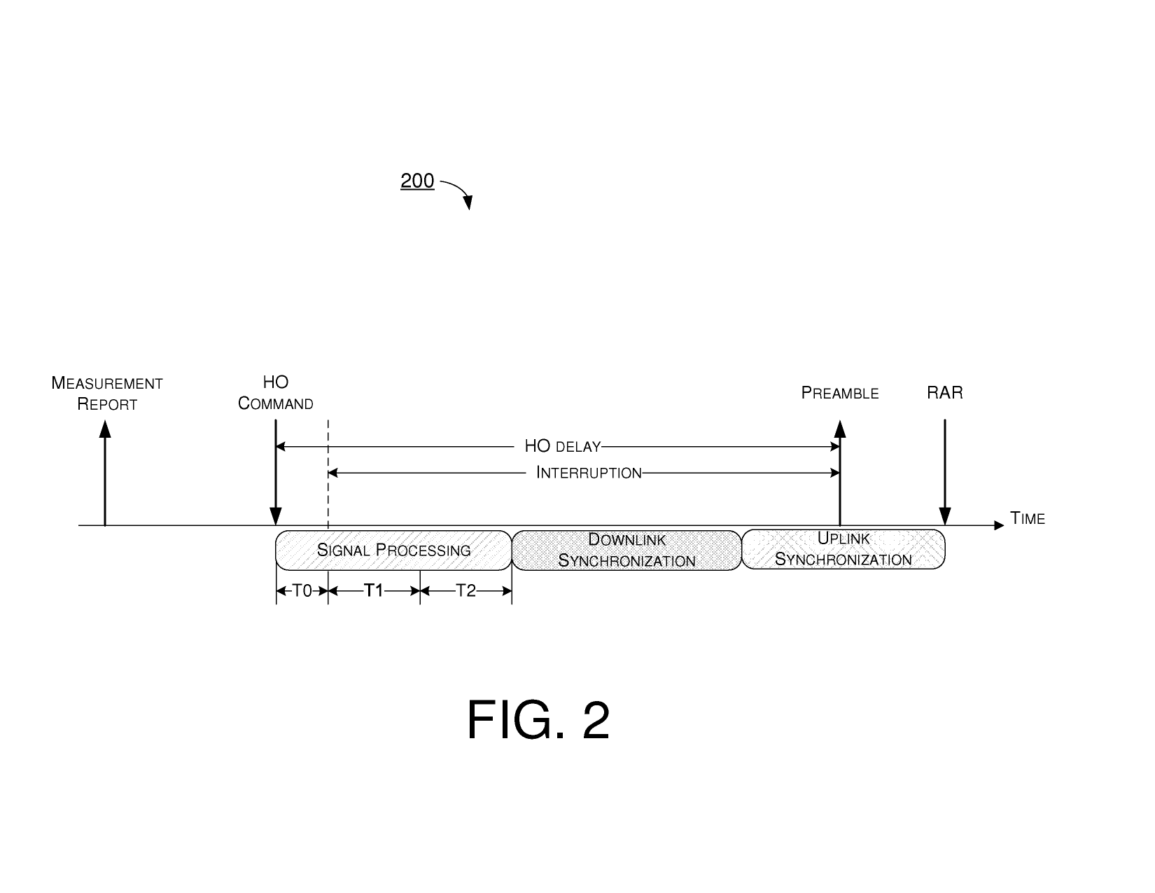

FIG. 2 illustrates an example scenario 200 of the handover procedure. The UE may receive a handover (HO) command after transmitting the measurement report to the gNB. The HO delay may start when the HO command is received. The HO command may typically consist of an RRC connection configuration/reconfiguration message that carries parameters associated with the target cell. The UE may perform necessary signal processing upon receiving the HO command.

The signal processing may be divided into several stages. In the first stage, the UE may decode the configuration/reconfiguration message associated with the target cell to obtain the parameters associated with the target cell. For example, the UE may perform the abstract syntax notation one (ASN.1) decoding and the validity check during the time interval T0 to obtain the parameters associated with the target cell. In the remaining stages, the UE may further process the obtained parameters.

More specifically, in the second stage and during the time interval T1, the UE may calculate or determine the values or parameters required for configuring the corresponding hardware modules, such as calculating or determining the L1, L2 and L3 configurations as mentioned above, based on the obtained parameters associated with the target cell. In the third stage and during the time interval T2, the UE may configure the corresponding hardware modules, such as setting the L1, L2 and L3 configurations as mentioned above, using the calculated parameters. Besides the necessary signal processing, the UE may further perform downlink synchronization and uplink synchronization with the target cell.

Typically, the source cell stops scheduling the UE after issuing the HO command. This results in a brief period known as handover interruption (denoted as “Interruption” in FIG. 2), during which the UE may not receive any scheduled data until the target cell successfully establishes the new connection. Note that the handover interruption may begin upon receiving the HO command or after the first stage of signal processing.

As part of the connection establishment, the UE may initiate the Random Access procedure by transmitting a preamble to the target cell. In response, the target cell may send a Random Access Response (RAR), which provides timing alignment information and allocates uplink resources for the UE, enabling the continuation of data transmission after the UE context is successfully activated in the target cell.

However, the interruption at the source cell may not necessarily occur right after the handover command. For instance, certain signal processing operations performed by the UE to facilitate the handover procedure may not result in communication interruption with the source cell.

In view of this, establishing a consistent timing reference between the UE and the gNB to accurately identify the onset of handover-induced interruption becomes a key factor. Achieving proper alignment between the UE and the gNB enables more accurate identification of handover interruption onset, helping minimize interruption time and optimize network resource allocation.

In the proposed techniques, methods, schemes and/or solutions for handover-related status reporting, the UE may transmit a report comprising information regarding the earliest time occasion that an interrupted time may start to a network node (e.g., the serving cell or the source cell managed by the corresponding gNB) to establish a consistent timing reference between the UE and the gNB. The information regarding the earliest time occasion that the interrupted time may start may indicate when there will be an interruption on the source cell due to handover to the target cell.

With the information regarding the earliest time occasion that the interrupted time may start, the UE and the gNB may accurately identify and align the onset of handover-induced interruption. In addition, with the information regarding the earliest time occasion that the interrupted time may start, the gNB may have knowledge of the remaining time available for scheduling downlink and/or uplink transmissions to the UE, or may determine the time at which it should stop scheduling the UE to avoid unnecessary consumption of network resources.

In some implementations, the report may be a status report for reporting the preparation status related to a handover procedure. The status report may be integrated or included in a measurement report or other report to be transmitted to the gNB, or the status report may contain measurement results as well. In some implementations, the status report may contain beam of the target cell to be used during the handover procedure and just after handover.

In some implementations, the report may be transmitted before receiving the handover command. The UE may receive the handover command after reporting the information regarding the earliest time occasion that the interrupted time may start, and communicate with the source cell after transmitting the report and before the interrupted time. That is, different from the legacy behaviors in which the source cell stops scheduling the UE after issuing the handover command, the source cell may keep scheduling the UE and the UE may keep communicating with the source cell within the uninterrupted time after receiving the handover command or before the interrupted time.

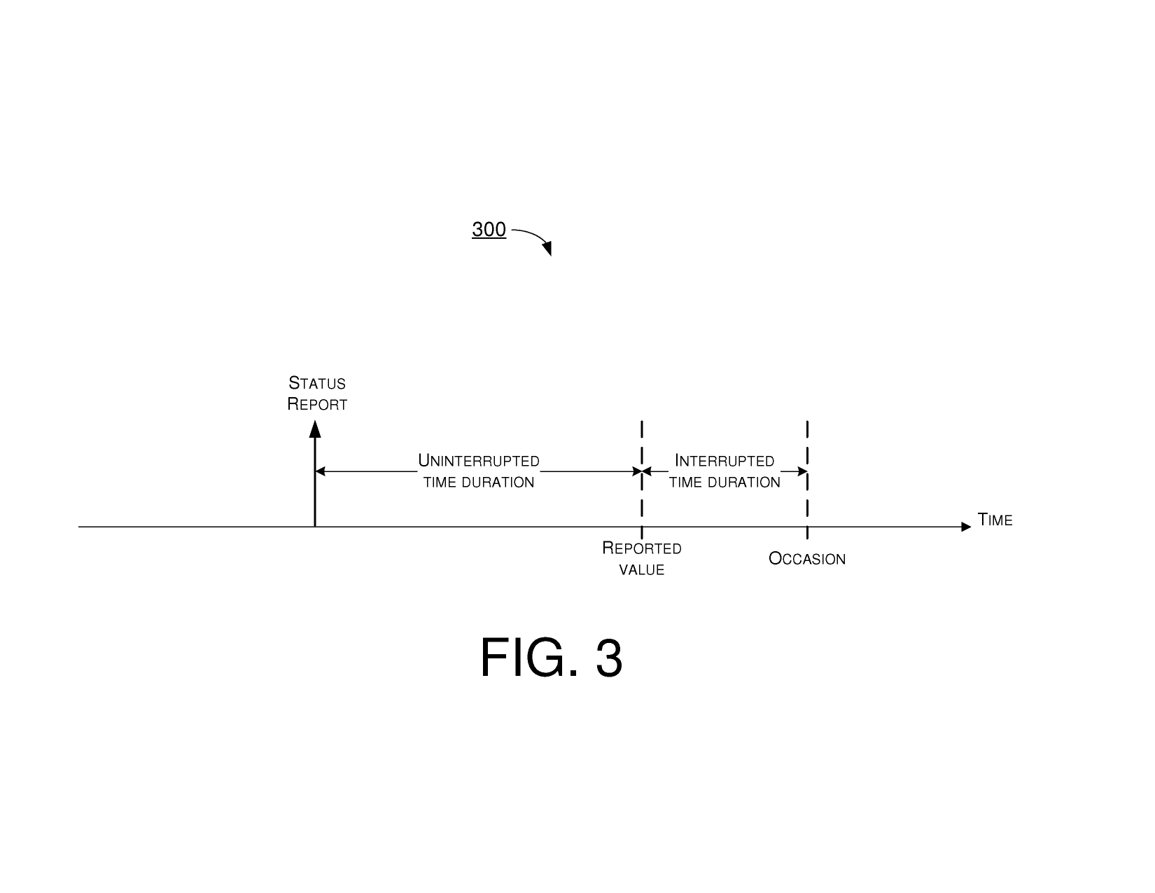

FIG. 3 illustrates an example scenario 300 under schemes in accordance with implementations of the present disclosure. The UE may perform at least one of the preparation operations (i.e., the handover-related preparation) associated with the handover to the target cell before transmitting the report or before receiving the handover command. The preparation operations may comprise an ASN.1 decoding of a configuration/reconfiguration message or a configuration/reconfiguration associated with the target cell, a validity check associated with the target cell, a downlink synchronization with the target cell, an uplink synchronization with the target cell or an UE processing (e.g., partial L1/L2/L3 signal processing) which is associated with the target cell and does not cause communication interruption to the source cell. The configuration or reconfiguration message associated with the target cell or the configuration or reconfiguration associated with the target cell may comprise a pre-configuration of the target cell received by the UE previously, and the preparation operations associated with the target cell may be performed based on the pre-configuration of the target cell. The target cell may be determined by the UE based on measurement results.

In some implementations, the UE may perform early downlink synchronization, and/or early uplink synchronization and/or early signal processing (such as the ASN.1 decoding, the validity check and partial L1/L2/L3 signal processing associated with handover to the target cell) autonomously or when some preconfigured condition is met. The UE may report the handover-related preparation status to the network node (i.e., the serving cell or the source cell managed by the corresponding gNB, hereinafter referred to as the source cell for brevity). In some implementations, the report (e.g., status report) may be triggered by some preconfigured condition or by a request from the source cell.

In some implementations, the preparation status may be reported in the form of the time duration needed to finish the remaining preparations. During the time duration after transmitting the report, a communication with the source cell remains uninterrupted (denoted as “Uninterrupted time duration” in FIG. 3). With this information, network can derive when the interruption time starts.

The UE may estimate the length of the time duration based on the preparation operations performed in advance or performed before the initiation of the handover procedure. Or, the UE may estimate the length of the time duration based on the remaining unperformed preparation operations which will or will not cause communication interruption to the source cell. The UE may carry the estimated length as the information regarding the earliest time occasion that the interrupted time may start in the report. In some implementations, the information regarding handover preparation status may be reported as one of several predefined values.

In some implementations, the handover command may be received after the uninterrupted time duration. As the UE may need time to decode the handover command, in this case, the interrupted time duration starts after the handover command is decoded.

In some implementations, the information regarding the earliest time occasion that the interrupted time may start may be reported as that the interruption will start no earlier than a time duration before the next N-th occasion configured to the UE, where N is a positive integer. The occasion may comprise a random access channel (RACH) occasion, or a physical uplink control channel (PUCCH) occasion, or a reference signal (RS) occasion. The interruption time is no earlier than a time duration ahead of the next N-th occasion after the report. In some implementations, the time duration may be reported by the UE or a predefined value. For example, the UE may estimate the earliest occasion that interruption may occur based on the preparation operations performed in advance or performed before the initiation of the handover procedure, or based on the remaining unperformed preparation operations which will or will not cause communication interruption to the source cell, and determine the value of N based on the estimated length. The UE may carry the value (denoted as “Reported value” in FIG. 3) as the information regarding the earliest time occasion that the interrupted time may start in the report.

In some implementations, the information regarding the earliest time occasion that the interrupted time may start may comprise information regarding which preparation operation has been performed (or which preparation operation has not been performed). The UE may carry the information regarding which preparation operation has or has not been performed as the information regarding the earliest time occasion that the interrupted time may start in the report. For example, the UE may carry the information regarding whether it has finished early downlink synchronization, early downlink synchronization, early signal processing including ASN.1 decoding and/or validity check and/or other preparation in the report.

In some implementations, the time required for each preparation operation may be predefined and known by the source cell, or may be determined by the UE and reported to the source cell (for example, via a capability report). The source cell may derive the earliest occasion that interruption occurs based on the time required for each preparation operation and the information regarding which preparation operation has or has not been performed. In some implementations, the information regarding which preparation operation has or has not been performed may also be reported as one or more of several predefined values.

In some implementations, the information regarding the earliest time occasion that the interrupted time may start may be determined according to at least one of a time required to perform one or more preparation operations associated with the handover to the target cell (i.e., the UE preparation time) and a network preparation time associated with the handover. For example, the UE or the source cell may derive the earliest time occasion that the interrupted time may start according to the maximum of the UE preparation time and the network preparation time associated with the handover. In some implementations, information regarding the earliest time occasion that the interrupted time may start may be reported as several predefined values or some predefined value(s) before an occasion after the report, and the predefined values may be the values defined directly or calculated by the predefined preparation time needed at the network and at the UE.

Take 5G NR as an example, the preparation time needed by the network for intra-CU (central unit) and inter-CU handover may be different. The target cell may also be prepared when the UE starts to transmit or receive data on the target cell, so the preparation time needed to get prepared at the network side may also be considered when determining the onset of handover-induced interruption in the serving cell and determining when the UE may start to transmit or receive data on the target cell. The network preparation time may be provided by the serving cell.

In addition, the UE may also arrange the time to perform the preparation operations which will cause communication interruption to the source cell according to the network preparation time. For example, the UE may arrange the time to perform the preparation operations which will cause communication interruption to the source cell, such as a portion of L1/L2/L3 signal processing and/or a portion of the uplink synchronization, so that the end time of the preparation operations can be aligned with the end time of network preparation, thereby reducing the overall handover interruption time. For another example, the UE may start to perform the preparation operations which will cause communication interruption to the source cell, such as a portion of L1/L2/L3 signal processing and/or a portion of the uplink synchronization, after expiry of the network preparation time (that is, after the target cell has been prepared to communicate with the UE).

From the source cell’s perspective, the source cell may receive a report comprising information regarding the earliest time occasion that the interrupted time may start from the UE, transmit a handover command to the UE and communicate with the UE after receiving the report and before the interrupted time.

The information regarding the earliest time occasion that the interrupted time may start may comprise a time duration after the report is transmitted and during which a communication with the UE will not be interrupted or a value associated with an interruption time duration before an N-th occasion configured to the UE.

The information regarding the earliest time occasion that the interrupted time may start may comprise information regarding which preparation operation associated with a handover to a target cell has been or has not been performed by the UE.

The source cell may derive the starting occasion of the interrupted time duration based on the information regarding the earliest time occasion that the interrupted time may start reported by the UE.

In some implementations, the source cell may transmit information regarding a network preparation time associated with a handover to the target cell to the UE. The information regarding the earliest time occasion that the interrupted time may start may be determined according to at least one of a time required by the UE to perform one or more preparation operations associated with the handover and the network preparation time.

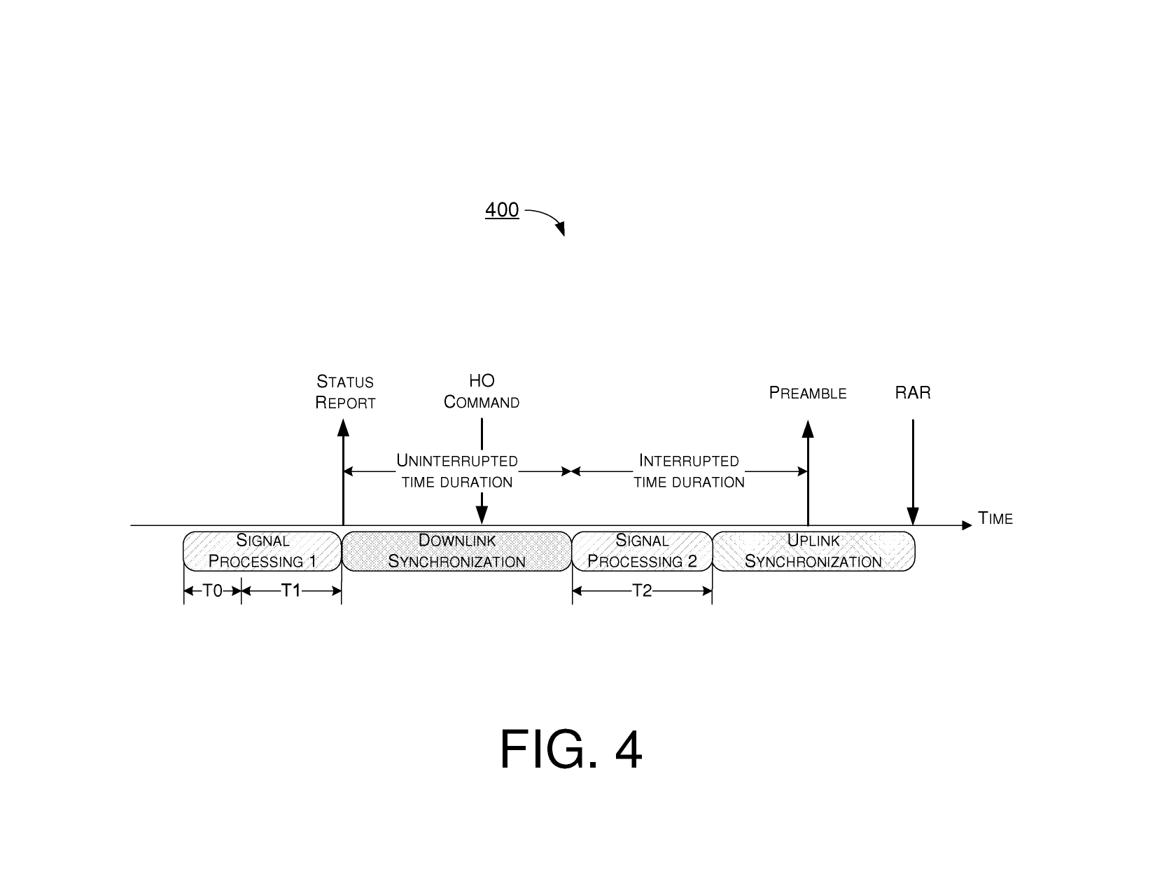

FIG. 4 illustrates an example scenario 400 under schemes in accordance with implementations of the present disclosure. In scenario 400, the UE has performed a portion of the handover-related signal processing (denoted as “Signal Processing 1” in FIG. 4) in advance before transmitting the status report or before receiving the handover command. The portion of the handover-related signal processing performed in advance may comprise, but not be limited to, the ASN.1 decoding and the validity check associated with the target cell (corresponding to the time interval T0), and calculation or determination of the configuration parameter related to the target cell (corresponding to the time interval T1). The portion of the handover-related signal processing (i.e., the “Signal Processing 1”) will not cause communication interruption to the source cell.

In some implementations, the UE may determine or estimate the earliest time occasion that the interrupted time may start based on the time required for the remaining unperformed preparation operations which will not cause communication interruption to the source cell, such as the time required for performing the downlink synchronization, and carry the estimated length as the information regarding the uninterrupted time or the earliest time occasion that the interrupted time may start in the status report.

In some other implementations, the UE may estimate the earliest occasion of when interruption time will occur based on the time required for the remaining unperformed preparation operations which will not cause communication interruption to the source cell, such as the time required for finishing DL synchronization. The UE may estimate the interruption length based on the time required for the actions that will cause interruption such as the time required for performing the other portion of the handover-related signal processing (denoted as “Signal Processing 2” corresponding to the time interval T2 in FIG. 4) and uplink synchronization. For example, the time required for the preparation operation Signal Processing 2 may be derived from the length of the corresponding time interval T2. The UE may also determine a value associated with the interruption time duration before the N-th occasion configured to the UE to indicate the information regarding the earliest time occasion that the interrupted time may start based on the time required for the remaining unperformed preparation operations which will cause communication interruption to the source cell, and determine N based on and the unperformed preparation operations for handover. The UE may carry the value as the information regarding the earliest time occasion that the interrupted time may start in the status report.

In yet some other implementations, the UE may carry information regarding which portion of the handover-related signal processing has been performed (e.g., the Signal Processing 1 in scenario 400) as the information regarding the earliest time occasion that the interrupted time may start in the status report. The source cell may derive the earliest time occasion that the interrupted time will start based on the time required for the remaining unperformed preparation operations which will not cause communication interruption to the source cell, as well as the occasion the cell sends the handover command.

Regardless of the implementation used, proper alignment of the timing reference, which enables accurate identification of the onset of handover-induced interruption, is ensured by both the UE and the source cell. Moreover, the interruption duration and network resource allocation may also be optimized accordingly. For example, after issuing the HO command, the source cell may continue scheduling transmissions for the UE or maintain communication with the UE within the uninterrupted time duration or until the UE starts executing the operations that actually result in communication interruption with the source cell.

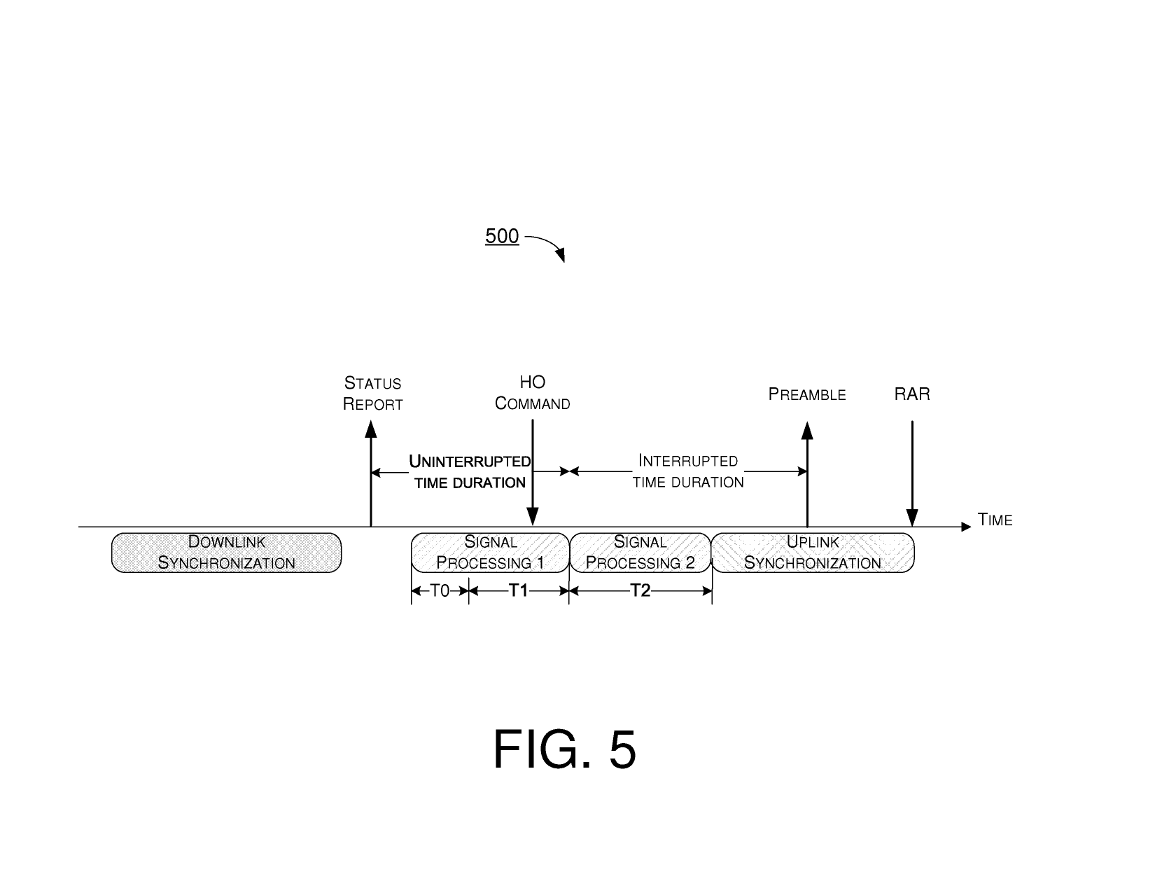

FIG. 5 illustrates an example scenario 500 under schemes in accordance with implementations of the present disclosure. In scenario 500, the UE has performed downlink synchronization with the target cell in advance before transmitting the status report or before receiving the handover command. The UE may determine or estimate the earliest time occasion that the interrupted time may start based on the time required for the remaining unperformed preparation operations which will not cause communication interruption to the source cell, such as the time required for performing the portion of the handover-related signal processing (denoted as “Signal Processing 1” in FIG. 5) that will not cause communication interruption to the source cell, and carry the estimated length as the information regarding the earliest time occasion that the interrupted time may start in the status report. For example, the time required for the preparation operation Signal Processing 1 may be derived from the length of the corresponding time intervals T0 and T1.

In some other implementations, the UE may estimate the length of the interrupted time duration based on the time required for the remaining unperformed preparation operations which will cause communication interruption to the source cell, such as the time required for performing the other portion of the handover-related signal processing (denoted as “Signal Processing 2” in FIG. 5) and uplink synchronization, and determine a value associated with the interruption time duration before the N-th occasion configured to the UE based on the estimated length. The UE may carry the value as the information regarding the interrupted time (or uninterrupted time) in the status report. The value N may be determined based on the unperformed preparation operations for handover.

In yet some other implementations, the UE may carry information regarding which preparation operations (e.g., the downlink synchronization in scenario 500) have been performed as the information regarding the earliest time occasion that the interrupted time may start in the status report. The source cell may derive the earliest time occasion that the interrupted time may start based on the time required for the remaining unperformed preparation operations which will not cause communication interruption to the source cell and/or based on the time required for the remaining unperformed preparation operations which will cause communication interruption to the source cell.

Regardless of the implementation used, proper alignment of the timing reference, which enables accurate identification of the onset of handover-induced interruption, is ensured by both the UE and the source cell. Moreover, the interruption duration and network resource allocation may also be optimized accordingly. For example, after issuing the HO command, the source cell may continue scheduling transmissions for the UE or maintain communication with the UE within the uninterrupted time duration or until the UE starts executing the operations that actually result in communication interruption with the source cell.

### Illustrative Implementations

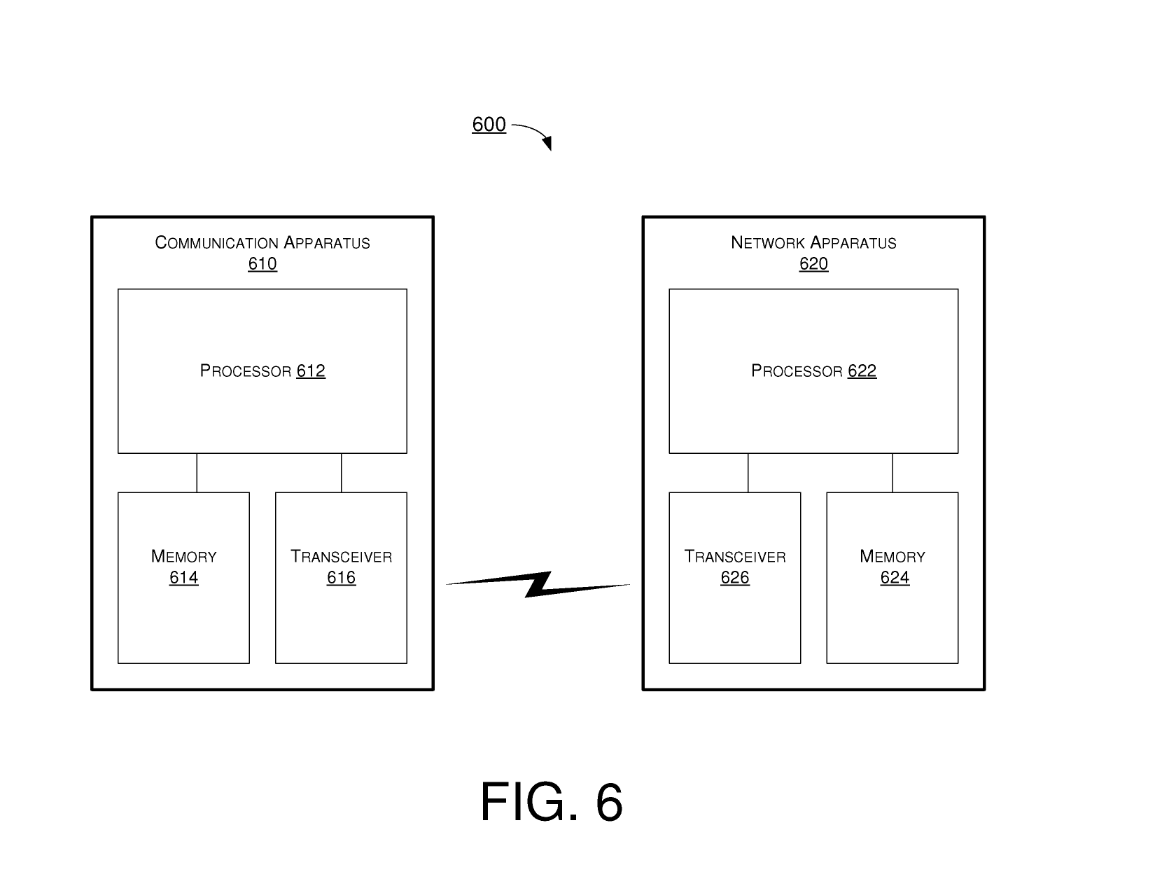

FIG. 6 illustrates an example communication system 600 having an example communication apparatus 610 and an example network apparatus 620 in accordance with an implementation of the present disclosure. Each of the communication apparatus 610 and the network apparatus 620 may perform various functions to implement schemes, techniques, processes and methods described herein pertaining to handover-related status reporting in mobile communications, including scenarios/schemes described above as well as the process 700 and the process 800 described below.

The communication apparatus 610 may be a part of an electronic apparatus, which may be a UE such as a portable or mobile apparatus, a wearable apparatus, a wireless communication apparatus or a computing apparatus. For instance, the communication apparatus 610 may be implemented in a smartphone, a smartwatch, a personal digital assistant, a digital camera, or a computing equipment such as a tablet computer, a laptop computer or a notebook computer. The communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 610 may be implemented in a smart thermostat, a smart fridge, a smart door lock, a wireless speaker or a home control center. Alternatively, the communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 610 may include at least some of those components shown in FIG. 6 such as a processor 612, for example. The communication apparatus 610 may further include one or more other components not pertinent to the proposed scheme of the present disclosure (e.g., internal power supply, display device and/or user interface device), and, thus, such component(s) of the communication apparatus 610 are neither shown in FIG. 6 nor described below in the interest of simplicity and brevity.

The network apparatus 620 may be a part of an electronic apparatus, which may be a network node such as a satellite, a BS, a small cell, a router, or a gateway of a 4G/5G/B5G/6G, NR, IoT, NB-IoT or IIoT network. Alternatively, the network apparatus 620 may be implemented in the form of one or more IC chips such as, for example and without limitation, one or more single-core processors, one or more multi-core processors, or one or more RISC or CISC processors. The network apparatus 620 may include at least some of those components shown in FIG. 6 such as a processor 622, for example. The network apparatus 620 may further include one or more other components not pertinent to the proposed scheme of the present disclosure (e.g., internal power supply, display device and/or user interface device), and, thus, such component(s) of the network apparatus 620 are neither shown in FIG. 6 nor described below in the interest of simplicity and brevity.

In one aspect, each of the processor 612 and the processor 622 may be implemented in the form of one or more single-core processors, one or more multi-core processors, or one or more CISC processors. That is, even though a singular term “a processor” is used herein to refer to the processor 612 and the processor 622, each of the processor 612 and the processor 622 may include multiple processors in some implementations and a single processor in other implementations in accordance with the present disclosure. In another aspect, each of the processor 612 and the processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 612 and the processor 622 is a special-purpose machine specifically designed, arranged and configured to perform specific tasks in accordance with various implementations of the present disclosure.

In some implementations, the communication apparatus 610 may also include a transceiver 616 coupled to the processor 612 and capable of wirelessly transmitting and receiving data. In some implementations, the transceiver 616 may be capable of wirelessly communicating with different types of UEs and/or wireless networks of different RATs. In some implementations, the transceiver 616 may be equipped with a plurality of antenna ports (not shown) such as, for example, four antenna ports. That is, the transceiver 616 may be equipped with multiple transmit antennas and multiple receive antennas for multiple-input multiple-output (MIMO) wireless communications. In some implementations, the network apparatus 620 may also include a transceiver 626 coupled to the processor 622 and capable of wirelessly transmitting and receiving data. In some implementations, the transceiver 626 may be capable of wirelessly communicating with different types of UEs of different RATs. In some implementations, the transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, the communication apparatus 610 may further include a memory 614 coupled to the processor 612 and capable of being accessed by the processor 612 and storing data therein. In some implementations, the network apparatus 620 may further include a memory 624 coupled to the processor 622 and capable of being accessed by the processor 622 and storing data therein. Each of the memory 614 and the memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of the memory 614 and the memory 624 may include a type of read-only memory (ROM) such as mask ROM, programmable ROM (PROM), erasable programmable ROM (EPROM) and/or electrically erasable programmable ROM (EEPROM). Alternatively, or additionally, each of the memory 614 and the memory 624 may include a type of non-volatile random-access memory (NVRAM) such as flash memory, solid-state memory, ferroelectric RAM (FeRAM), magnetoresistive RAM (MRAM) and/or phase-change memory.

Each of the communication apparatus 610 and the network apparatus 620 may be a communication entity capable of communicating with each other using various proposed schemes in accordance with the present disclosure. For illustrative purposes and without limitation, a description of capabilities of the communication apparatus 610, as a UE, and the network apparatus 620, as a network node, is provided below with the processes 700 and 800.

### Illustrative Processes

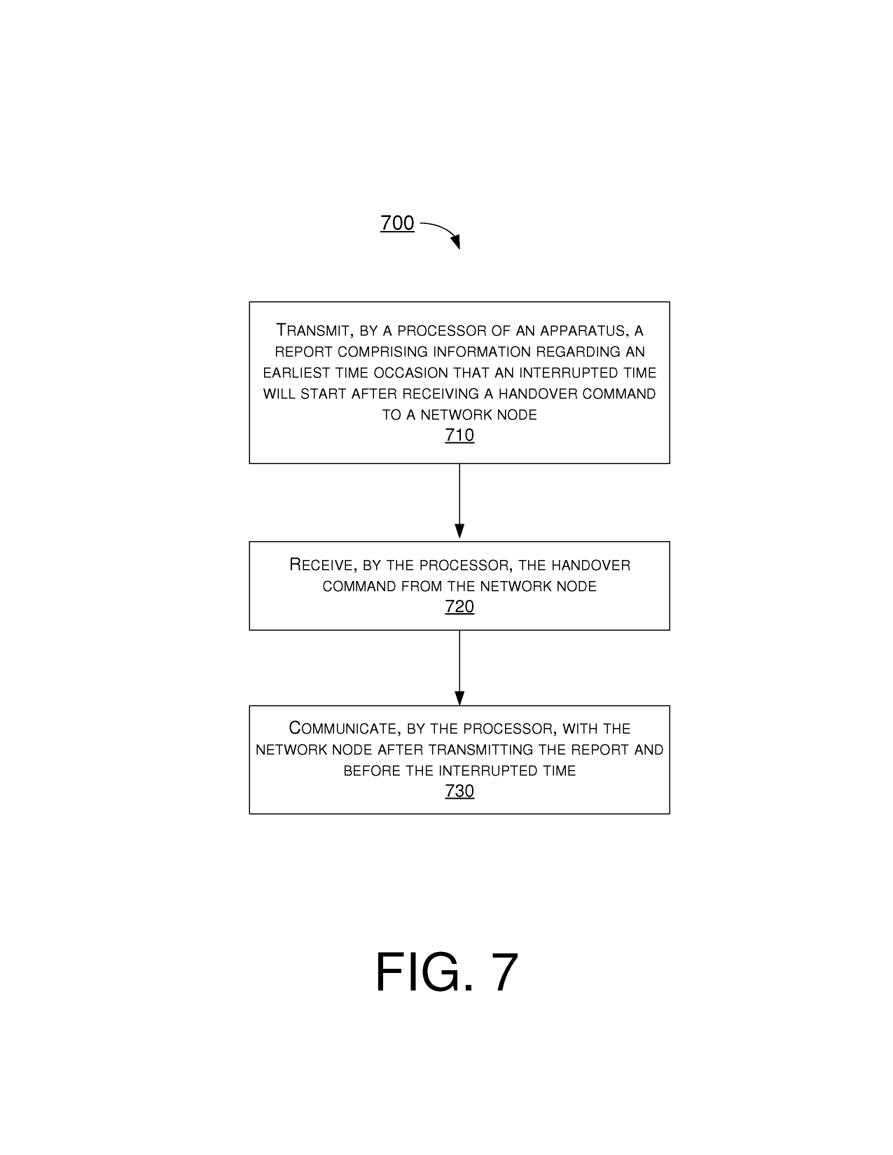

FIG. 7 illustrates an example process 700 in accordance with an implementation of the present disclosure. The process 700 may be an example implementation of above scenarios/schemes, whether partially or completely, including those described above with respect to handover-related status reporting in mobile communications. The process 700 may represent an aspect of implementation of features of the communication apparatus 610. The process 700 may include one or more operations, actions, or functions as illustrated by one or more of blocks 710, 720 and 730. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by the communication apparatus 610. Solely for illustrative purposes and without limitation, the process 700 is described below in the context of the communication apparatus 610. The process 700 may begin at block 710.

At block 710, the process 700 may involve the processor 612 of the communication apparatus 610 transmitting a report comprising information regarding an earliest time occasion that an interrupted time will start after receiving a handover command to the network apparatus 620. The process 700 may proceed from block 710 to block 720.

At block 720, the process 700 may involve the processor 612 receiving the handover command from the network apparatus 620. The process 700 may proceed from block 720 to block 730.

At block 730, the process 700 may involve the processor 612 communicating with the network apparatus 620 after transmitting the report and before the interrupted time.

In some implementations, the information regarding the earliest time occasion that the interrupted time will start may comprise a time duration after transmitting the report and during which a communication with the network apparatus 620 will not be interrupted.

In some implementations, the information regarding the earliest time occasion that the interrupted time will start may comprise a value associated with an interruption time duration before an N-th occasion after the report, wherein N may be a positive integer.

In some implementations, the N-th occasion may be configured to the communication apparatus 610, and the occasion may comprise a RACH occasion, or a PUCCH occasion, or an RS occasion.

In some implementations, the process 700 may further involve the processor 612 performing at least one of preparation operations associated with a handover to a target cell before transmitting the report.

In some implementations, the information regarding the earliest time occasion that the interrupted time will start may comprise information regarding which preparation operation has been performed or has not been performed.

In some implementations, the preparation operations may comprise an ASN.1 decoding of a configuration message associated with the target cell, a validity check associated with the target cell, a downlink synchronization with the target cell, an uplink synchronization with the target cell and a processing of the communication apparatus 610 which does not cause communication interruption to the network apparatus 620.

In some implementations, the information regarding the earliest time occasion that the interrupted time will start may be determined according to at least one of a time required to perform one or more preparation operations associated with a handover to a target cell and a network preparation time associated with the handover.

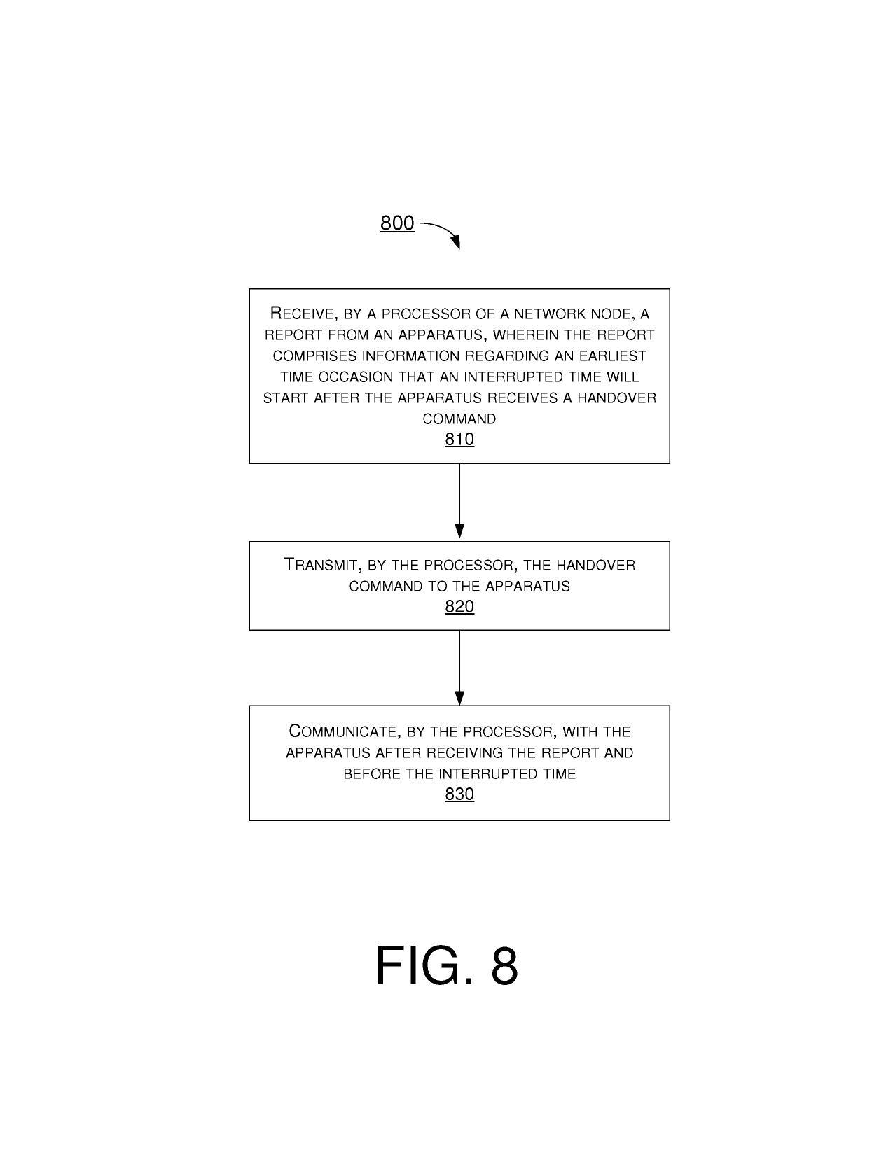

FIG. 8 illustrates an example process 800 in accordance with an implementation of the present disclosure. The process 800 may be an example implementation of above scenarios/schemes, whether partially or completely, including those described above with respect to handover-related status reporting in mobile communications. The process 800 may represent an aspect of implementation of features of the network apparatus 620. The process 800 may include one or more operations, actions, or functions as illustrated by one or more of blocks 810, 820 and 830. Although illustrated as discrete blocks, various blocks of the process 800 may be divided into additional blocks, combined into fewer blocks, or eliminated, depending on the desired implementation. Moreover, the blocks of the process 800 may be executed in the order shown in FIG. 8 or, alternatively, in a different order. The process 800 may be implemented by the network apparatus 620 as well as any variations thereof. Solely for illustrative purposes and without limitation, the process 800 is described below in the context of the network apparatus 620. The process 800 may begin at block 810.

At block 810, the process 800 may involve the processor 622 of the network apparatus 620 receiving a report from the communication apparatus 610. The report may comprise information regarding an earliest time occasion that an interrupted time will start after the communication apparatus 610 receives a handover command. The process 800 may proceed from block 810 to block 820.

At block 820, the process 800 may involve the processor 622 transmitting the handover command to the communication apparatus 610. The process 800 may proceed from block 820 to block 830.

At block 830, the process 800 may involve the processor 622 communicating with the communication apparatus 610 after receiving the report and before the interrupted time.

In some implementations, the information regarding the earliest time occasion that the interrupted time will start may comprise a time duration after the report is transmitted and during which a communication with the communication apparatus 610 will not be interrupted or a value associated with an interruption time duration before an N-th occasion after the report, wherein N may be a positive integer.

In some implementations, the information regarding the earliest time occasion that the interrupted time will start may comprise information regarding which preparation operation associated with a handover to a target cell has been or has not been performed by the communication apparatus 610.

In some implementations, the process 800 may further involve the processor 622 transmitting information regarding a network preparation time associated with a handover to a target cell to the communication apparatus 610. The information regarding the earliest time occasion that the interrupted time will start may be determined according to at least one of a time required by the communication apparatus 610 to perform one or more preparation operations associated with the handover and the network preparation time.

Throughout this specification, the terms “uplink synchronization”, “downlink synchronization”, “ASN.1 decoding”, “validity check” and “L1/L2/L3 processing” have been used to describe various aspects of the disclosed technology. It should be understood that these terms, as well as any other terminology used herein, are not intended to be limiting. The disclosed implementations may be referred to by other names or terms in various sources of material, but such alternative names or terms shall be understood to encompass the corresponding elements described herein. Accordingly, any equivalent terms or nomenclature that convey the same or substantially similar meaning as the terms used in this disclosure are intended to fall within the scope of the claims of this patent, even if such terms are not explicitly used in the claims. The use of different terminology or nomenclature that conveys the same functional or structural characteristics as the elements described herein is intended to be within the scope of the present invention.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a report comprising information regarding an earliest time occasion that an interrupted time will start after receiving a handover command to a network node;
receiving, by the processor, the handover command from the network node; and
communicating, by the processor, with the network node after transmitting the report and before the interrupted time.

2. The method of claim 1, wherein the information regarding the earliest time occasion that the interrupted time will start comprises a time duration after transmitting the report and during which a communication with the network node will not be interrupted.

3. The method of claim 1, wherein the information regarding the earliest time occasion that the interrupted time will start comprises a value associated with an interruption time duration before an N-th occasion after the report, wherein N is a positive integer.

4. The method of claim 3, wherein the N-th occasion is configured to the apparatus, and comprises a random access channel (RACH) occasion, or a physical uplink control channel (PUCCH) occasion, or a reference signal (RS) occasion.

5. The method of claim 1, further comprising:
performing, by the processor, at least one of preparation operations associated with a handover to a target cell before transmitting the report.

6. The method of claim 5, wherein the information regarding the earliest time occasion that the interrupted time will start comprises information regarding which preparation operation has been performed or has not been performed.

7. The method of claim 5, wherein the preparation operations comprise an abstract syntax notation one (ASN.1) decoding of a configuration message associated with the target cell, a validity check associated with the target cell, a downlink synchronization with the target cell, an uplink synchronization with the target cell and a processing which does not cause communication interruption to the network node.

8. The method of claim 1, wherein the information regarding the earliest time occasion that the interrupted time will start is determined according to at least one of a time required to perform one or more preparation operations associated with a handover to a target cell and a network preparation time associated with the handover.

9. An apparatus, comprising:
a transceiver which, during operation, wirelessly communicates with at least one network node; and
a processor communicatively coupled to the transceiver such that, during operation, the processor performs operations comprising:
transmitting, via the transceiver, a report comprising information regarding an earliest time occasion that an interrupted time will start after receiving a handover command to the network node;
receiving, via the transceiver, the handover command from the network node; and
communicating, via the transceiver, with the network node after transmitting the report and before the interrupted time.

10. The apparatus of claim 9, wherein the information regarding the earliest time occasion that the interrupted time will start comprises a time duration after transmitting the report and during which a communication with the network node will not be interrupted.

11. The apparatus of claim 9, wherein the information regarding the earliest time occasion that the interrupted time will start comprises a value associated with an interruption time duration before an N-th occasion after the report, wherein N is a positive integer.

12. The apparatus of claim 11, wherein the N-th occasion is configured to the apparatus, and comprises a random access channel (RACH) occasion, or a physical uplink control channel (PUCCH) occasion, or a reference signal (RS) occasion.

13. The apparatus of claim 9, wherein, during operation, the processor further performs operations comprising:
performing at least one of preparation operations associated with a handover to a target cell before transmitting the report.

14. The apparatus of claim 13, wherein the information regarding the earliest time occasion that the interrupted time will start comprises information regarding which preparation operation has been performed or has not been performed.

15. The apparatus of claim 13, wherein the preparation operations comprise an abstract syntax notation one (ASN.1) decoding of a configuration message associated with the target cell, a validity check associated with the target cell, a downlink synchronization with the target cell, an uplink synchronization with the target cell and a processing which does not cause communication interruption to the network node.

16. The apparatus of claim 9, wherein the information regarding the earliest time occasion that the interrupted time will start is determined according to at least one of a time required to perform one or more preparation operations associated with a handover to a target cell and a network preparation time associated with the handover.

17. A method, comprising:
receiving, by a processor of a network node, a report from an apparatus, wherein the report comprises information regarding an earliest time occasion that an interrupted time will start after the apparatus receives a handover command;
transmitting, by the processor, the handover command to the apparatus; and
communicating, by the processor, with the apparatus after receiving the report and before the interrupted time.

18. The method of claim 17, wherein the information regarding the earliest time occasion that the interrupted time will start comprises a time duration after the report is transmitted and during which a communication with the apparatus will not be interrupted, or a value associated with an interruption time duration before an N-th occasion after the report, wherein N is a positive integer.

19. The method of claim 17, wherein the information regarding the earliest time occasion that the interrupted time will start comprises information regarding which preparation operation associated with a handover to a target cell has been or has not been performed by the apparatus.

20. The method of claim 17, further comprising:
transmitting, by the processor, information regarding a network preparation time associated with a handover to a target cell to the apparatus,
wherein the information regarding the earliest time occasion that the interrupted time will start is determined according to at least one of a time required by the apparatus to perform one or more preparation operations associated with the handover and the network preparation time.
